(19) United States
(12) Patent Application Publication
(10) Pub. No.: US 2015/0035672 A1
(43) Pub. Date: Feb. 5, 2015

(54) PROXIMITY TRACKING SYSTEM

(71) Applicants: Shannon Housley, Hayward, CA (US); Glenda Housley, Hayward, CA (US)

(72) Inventors: Shannon Housley, Hayward, CA (US); Glenda Housley, Hayward, CA (US)

(21) Appl. No.: 14/517,625

(22) Filed: Oct. 17, 2014

Related U.S. Application Data
(63) Continuation-in-part of application No. 13/708,178, filed on Dec. 7, 2012.

(51) Int. Cl. G08B 21/02; G08B 21/22

(52) U.S. Cl. CPC G08B 21/0288; G08B 21/22
USPC 340/539.13

(57) ABSTRACT

A proximity tracking system for selectively alerting a custodian when a child becomes located outside a predetermined proximity of the custodian comprises a battery powered custodian component, defined in one embodiment as a modified bracelet with a set of command features, for custodian to wear, as well as a corresponding battery powered child component that is attachable to the person or clothing of a child to be monitored. The custodian component and child component are configured to communicate wirelessly with one another to determine their relative proximity. The custodian component allows a user to select one of a pre-determined distance at which its alerting features are activated. Accordingly, in operation, when a child wearing the child component reaches the selected predetermined distance from the custodian component, the child component will begin to flash lights integrated therein and emit an audible alarm in order to alert the custodian.

### CROSS REFERENCE TO RELATED APPLICATIONS

This application is a continuation in part of, claims the benefit of, and incorporates by reference co-pending U.S. patent application Ser. No. 13/708,178, filed Dec. 7, 2012.

### BACKGROUND OF THE INVENTION

1. Field of the Invention

This invention relates generally to a proximity tracking system and, more particularly, to an alert system that provides a plurality of sensory indications when a tracking wearable device, such as a modified ring, exits a defined proximity from a monitoring wearable device, such as a modified bracelet.

2. Description of the Prior Art

It is well known that when in public places or otherwise relatively unrestrained environments, children generally require ongoing supervision, particularly the monitoring of their location in order to ensure their safety. It is similarly well established that in many cases, elderly or special needs persons may require the same or a similar type of monitoring. In such environments, even with the best efforts of the person(s) charged with supervising, such as parents, relatives, supervisors and/or caregivers (collectively referred to herein as “custodians”), situations will occur where the custodian and the child, elderly person, or special needs person (referenced herein as simply “child” for ease of reference) become separated. While such separation may be inadvertent or voluntary, in either case, the custodian often desires to locate the child quickly to verify their safety.

Common solutions for preventing a child from becoming separated for a custodian often employ some form of tether or leash that physically attaches the child to the custodian. A problem with such solutions, however, is that the use of a physical tether can be dangerous at the custodian and child are walking through a populated area and are substantially useless in the event the child or custodian has to use a restroom or otherwise temporarily enter an enclosed area. Thus, there remains a need for a proximity tracking system which employs wireless communications to determine and monitor the proximity of a custodian to a child. It would be helpful if such a proximity tracking system employed discrete, wearable components that were conveniently deployed on both a custodian and child. It would be additionally desirable if such a proximity tracking system included automatic alert settings as well as manual alert settings controllable from the custodian component.

The Applicant's invention described herein provides for a proximity tracking system adapted to allow wireless monitoring and alerting of a child's proximity to a custodian. The primary components of Applicant's proximity tracking system are a custodian (or caregiver) component and a child (or caretaker) component, communicatively connected to each other through a wireless electronic communication protocol. When in operation, the proximity tracking system allows a custodian to selectively ensure their child is within a desired proximity when the custodian and/or the child are in a relatively unrestrained environment. As a result, many of the limitations imposed by the prior art structures are removed.

### SUMMARY OF THE INVENTION

A proximity (or bracelet) tracking system for selectively alerting a custodian when a child becomes located outside a predetermined proximity of the custodian. The proximity tracking system includes a battery powered custodian component, defined in one embodiment as a monitoring bracelet with a set of command features, for custodian to wear, as well as a corresponding battery powered child component, defined in one embodiment as a tracking ring, that is attachable to the person or clothing of a child to be monitored. The custodian component and child component are configured to communicate wirelessly with one another to determine their relative proximity. The custodian component allows a user to select one of a pre-determined distance, 15 feet, 30 feet and 50 feet in the preferred embodiment, at which its alerting features are activated. Accordingly, in operation, when a child wearing the child component reaches the selected predetermined distance from the custodian component, the child component will begin to flash lights integrated therein and emit an audible alarm in order to alert the custodian.

It is an object of this invention to provide a need for a proximity tracking system which employs wireless communications to determine and monitor the proximity of a custodian to a child.

It is another object of this invention to provide a proximity tracking system that employs discrete, wearable components that were conveniently deployed on both a custodian and child.

It is yet another object of this invention to provide a proximity tracking system that included automatic alert settings as well as manual alert settings controllable from the custodian component.

These and other objects will be apparent to one of skill in the art.

### BRIEF DESCRIPTION OF THE DRAWINGS

FIG. 1 is an environmental perspective view of a proximity tracking system built in accordance with the present invention.

FIG. 2 is a front perspective view of embodiments of a custodian component and a child component of a proximity tracking system built in accordance with a single child embodiment of the present invention.

### DETAILED DESCRIPTION OF THE INVENTION

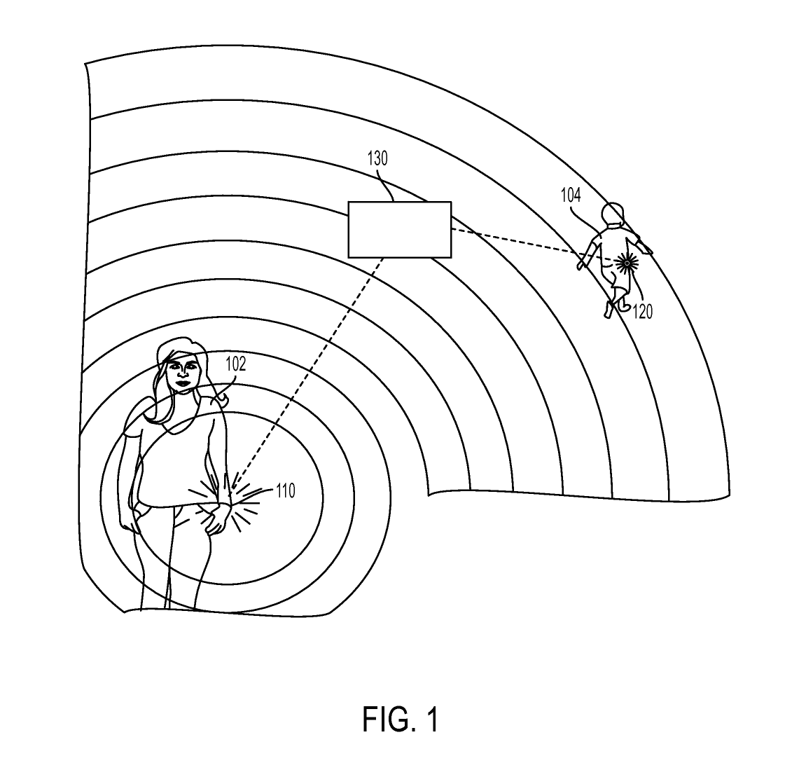

Referring now to the drawings and in particular FIG. 1, a proximity tracking system is shown as a custodian component defined as a monitoring bracelet 110 and a child component defined as a tracking ring 120 that in wireless communication with one another through a communications technology 130. The monitoring bracelet 110 is worn by a person who seeks to monitor the relative location of a child, elderly person, or special needs person, defined herein as a custodian 102. Accordingly, it is understood that the custodian 102 may often be a parent but could be any caregiver such as a babysitter, a pet owner, or a healthcare worker. In the preferred embodiment, both the monitoring bracelet 110 and the tracking ring 120 are waterproof and can be utilized at a suitable body of water and its vicinity such as a beach, a lake or a pool area.

The tracking ring 120 is worn by an individual of whom the custodian seeks to monitor the relative location. Thus, depending on the identity of the custodian, the tracking ring may be worn by a child 104 as is illustrated in FIG. 1, or another being as desired by the custodian such as a pet, an elderly person or a special needs person. As it is contemplated that the child component is to be worn by the monitored individual, in some embodiments the child component may define an alternative small, wearable object such as a hair clip, an animal collar, a piece of clothing or a shoelace.

The communications technology 130 defines a wireless data transmission protocol that enables both the real time quantification of the distance of the tracking ring 120 from the monitoring bracelet 110 and the real time wireless communication of data between the monitoring bracelet 110 and the tracking ring 120. In the preferred embodiment, the communications technology 130 employs space-based satellite navigation technology, defined as the Global Positioning System (“GPS”) to provide real time distance quantification and employs wireless personal area network technology to facilitate the real time wireless communication between the devices. Real time distance quantification is provided through the presence of a GPS receiver in both the monitoring bracelet 110 and the tracking ring 120 as well as a processing element and non-transitory memory on the monitoring bracelet 110 or in both of the devices to calculate their relative distance based on their respective GPS determined positions. The wireless personal area network technology is implemented through a discrete antenna on each of the monitoring bracelet 110 and the tracking ring 120 for establishing intrapersonal communication of electronic data between the two devices. In one embodiment, the Bluetooth standard is employed for the wireless personal area network.

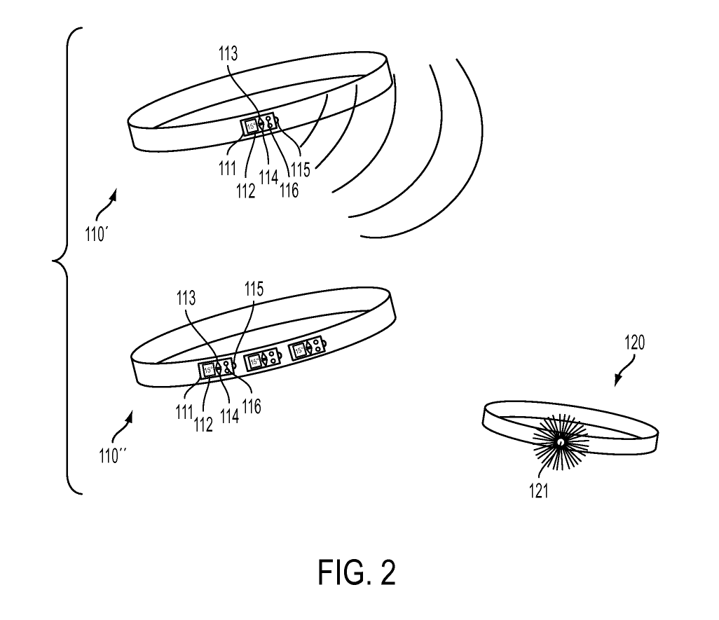

Referring now to FIGS. 1, 2 and 3, the custodian component may define a single tracking monitoring bracelet 110′ or a multiple tracking monitoring bracelet 110″ (collectively referred to as monitoring bracelet 110). Externally, the monitoring bracelet 110 includes a tracking device interface 111 for each child component it monitors the proximity of. Each tracking device interface 111 includes digital display screen 112, a change proximity push button switch 113, an automatic reset push button switch 114, an emergency push button switch 115, and custodian indicator lights 116.

Internally, the monitoring bracelet 110 includes a processing element, such as a processor (not shown), non-transitory memory, a GPS receiver, a Bluetooth antenna, a vibrator, a speaker, and a power supply, defined as a battery. These internal components are electronically connected with one another and with each tracking device interface 111 on the monitoring bracelet 110.

When the monitoring bracelet 110 is in operation, the digital display screen 112 displays whatever predetermined distance limit is currently selected for the child component associated with the tracking device interface 111 on which it is disposed. In the preferred embodiment, the predetermined distance limit can be set at approximately 15 feet, 30 feet, 50 feet or any other suitable distance. The change proximity push button switch 113 is operative to cycle through the preprogrammed distance limits for the generation of proximity alerts. Accordingly, in normal operation of the monitoring bracelet 110, when the associated child component moves from a location within the selected distance limit to outside of that distance limit, a proximity red alert is generated. In some embodiments, a proximity yellow alert is generated whenever the associated child component moves to a location that is adjacent to the selected distance limit, defined in the preferred embodiment as 90% of the selected distance limit from the monitoring bracelet 110. In alternate embodiments, the proximity yellow alert may be set for other distances that approach the selected distance limit.

On the monitoring bracelet 110, the proximity red alert is defined by the simultaneous flashing of the custodian indicator lights 116, vibrating of the vibrator, and broadcasting of an audible alarm sound over the speaker. A proximity yellow alert is defined by just the vibrating of the vibrator on the monitoring bracelet 110 (or otherwise the actuation of just one of the sensory alerting generators). It is contemplated that the custodian indicator lights 116 may be embodied as light-emitting diodes or other conventional electrical illuminating device.

The automatic reset push button switch 114 provides a manual bypass for the normal operation of the monitoring bracelet 110. When the automatic reset push button switch 114 is used when the associated child component is purposefully taken beyond the selected distance limit in effect at the time to quiet the proximity alert on the monitoring bracelet 110 and cause the normal proximity monitoring operation of the monitoring bracelet 110 to resume automatically as soon as the associate child component returns to a location within the selected distance limit. The automatic reset push button switch 114 is advantageously employed when the child being tracked is being moved from within the proximity purposefully for a temporary purpose as it does not require a shut off of the system and automatically resumes monitoring on the child's return, eliminating the chance of the custodian forgetting to resume monitoring in such a scenario.

The emergency push button switch 115 is operative to cause the transmission of a proximity red alert signal to the associated child component without causing the proximity red alert features to actuate on the monitoring bracelet 110. As such, a custodian whose child is in range but out of sight can be easily located without requiring the monitoring bracelet to generate its sensory alerting generators.

The GPS receiver is operative to provide precise position information to the monitoring bracelet's 110 processor, while the Bluetooth antenna is operative to directly connect to and communicate electronic data with the child component. In the preferred embodiment, the monitoring bracelet 110 receives precise position information from the child component as well as transmits proximity red alert statuses to the child component when generated.

It is contemplated that the multiple tracking monitoring bracelets 110″ include several identical tracking device interfaces 111 that are each associated with a single child component. As the plurality of tracking device interfaces 111 would operate sharing the internal components in such a configuration, it is contemplated that distinct vibration patterns and audible sounds would be associate with each tracking device interface 111.

Referring now to FIGS. 1 and 4, the child component may define a tracking ring 120 that includes an external child indicator light 121 as well as an internal speaker, Bluetooth antenna, a GPS receiver, and a power supply, defined as a battery in one embodiment, operative to supply electrical power to the light 121, antenna and receiver. The child indicator light 121, defined as an LED in the preferred embodiment, and the speaker are operative to flash and emit an audible alarm sound, respectively, when a proximity red alert signal is received by the Bluetooth antenna. The GPS receiver is operative to transmit precise location information in real time to the custodian component over the Bluetooth antenna.

It is contemplated that the custodian component takes the real time location information from the tracking ring 120 and compare it to the location information received from its own GPS receiver to determine in real time the precise distance the tracking ring 120 is from the monitoring bracelet. In one embodiment, the custodian component additionally determines the direction the tracking ring 120 is relative thereto and can provide a visual indication of the same.

In one embodiment, an alternate wireless serial communications protocol is used to established interpersonal communication.

In an alternate embodiment, the communications technology employed is an RFID system with an RFID reader disposed in the custodian component and an active RFID tag in the child component. In such an embodiment, whenever the RFID tag exits from within range of the RFID reader, a proximity red alert is generated. It is appreciated that this eliminates the requirement of having a discrete positioning system and communication system.

It is contemplated that the proximity tracking system may alternatively be employed on animals, such as dogs.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A proximity tracking system, comprising:
at least one child component, each configured to attach to an individual whose proximity is to be monitored, wherein each of said at least one child components include at least one child sensory alert generators and a child communications technology module, each of which is connected to a child power supply;
a custodian component for monitoring relative location of each of the at least one child components, wherein said custodian component includes a tracking device interface associated with each child component monitored, a plurality of custodian sensory alert generators and a custodian communications technology module, each connected to a custodian power supply, with each of said tracking device interfaces having a visual alert generator;
said custodian communications technology module enables both real time physical position determination of each child component relative to the custodian component and real time wireless communication with each child component;
said child communications technology module enables both real time physical position determination of the child component relative to the custodian component and real time wireless communication with the custodian component; and
wherein each of said tracking device interfaces are configured to generate a proximity red alert signal that causes each of the associated child sensory alert generators to actuate, each of the plurality of custodian sensory alert generators to actuate, and its visual alert generator to flash when the associated child component moves to a position outside of a predetermined distance from the custodian component.

2. The proximity tracking system of claim 1, wherein each said at least one child sensory alert generator is defined as one of at least one child indicator light configured to flash upon generation of the proximity red alert and a child speaker configured to emit an audible alarm sound from the custodian component upon generation of the proximity red alert.

3. The proximity tracking system of claim 1, wherein said custodian sensory alert generators are defined as a vibrator configured to cause the custodian component to vibrate upon generation of the proximity red alert and a custodian speaker configured to emit an audible alarm sound from the custodian component upon generation of the proximity red alert.

4. The proximity tracking system of claim 1, wherein the custodian component is configured to generate a proximity yellow alert signal that causes one of the plurality of custodian sensory alert generators to actuate when the at least one child component moves to a position substantially adjacent to the predetermined distance from the custodian component.

5. The proximity tracking system of claim 1, wherein each of said tracking device interfaces include a change proximity switch that enables manual selection of the predetermined distance for the associated child component.

6. The proximity tracking system of claim 1, wherein each of said tracking device interfaces include an automatic reset switch that, upon manual actuation, cancels the generation of the proximity alert when the associated child component is moved beyond the predetermined distance and restores the proximity red alert generation function automatically as soon as the associated child component returns to a location within the predetermined distance.

7. The proximity tracking system of claim 1, wherein each of said tracking device interfaces include a display screen that displays the predetermined distance.

8. The proximity tracking system of claim 1, wherein the custodian component includes an emergency switch is operative to cause each of the at least one child sensory alert generators to actuate without causing the custodian sensory alert sensors to actuate.

9. The proximity tracking system of claim 1, wherein the child communications technology module includes a child GPS receiver and a child wireless personal area network antenna.

10. The proximity tracking system of claim 1, wherein the custodian communications technology module includes a custodian GPS receiver and a custodian wireless personal area network antenna.

11. The proximity tracking system of claim 1, wherein the custodian component is wearable.

12. The proximity tracking system of claim 1, wherein the custodian component is configured to monitor at least two discrete child components at the same time.

13. A proximity tracking system, comprising:
a child component configured to attach to an individual whose proximity is to be monitored, wherein said child component includes at least one child sensory alert generators and a child communications technology module, both connected to a child power supply;
a wearable custodian component for monitoring relative location of each of the at least one child components, wherein said custodian component includes a plurality of custodian sensory alert generators and a custodian communications technology module, each connected to a custodian power supply;
said custodian communications technology module that includes a custodian GPS receiver and a custodian wireless personal area network antenna and enables both real time physical position determination of the child component relative to the custodian component and real time wireless communication with the child component;
said child communications technology module that includes a child GPS receiver and a child wireless personal area network antenna and enables both real time physical position determination of the child component relative to the custodian component and real time wireless communication with the custodian component; and
wherein said custodian component is configured to generate a proximity red alert signal that causes each of the child sensory alert generators to actuate and each of the plurality of custodian sensory alert generators to actuate when the associated child component moves to a position outside of a predetermined distance from the custodian component.

14. The proximity tracking system of claim 13, wherein each said at least one child sensory alert generator is defined as one of at least one child indicator light configured to flash upon generation of the proximity red alert and a child speaker configured to emit an audible alarm sound from the custodian component upon generation of the proximity red alert.

15. The proximity tracking system of claim 13, wherein said custodian sensory alert generators are defined as at least one custodian indicator light configured to flash upon generation of the proximity red alert, a vibrator configured to cause the custodian component to vibrate upon generation of the proximity red alert, and a custodian speaker configured to emit an audible alarm sound from the custodian component upon generation of the proximity red alert.

16. The proximity tracking system of claim 13, wherein the custodian component is configured to generate a proximity yellow alert signal that causes one of the plurality of custodian sensory alert generators to actuate when the child component moves to a position substantially adjacent to the predetermined distance from the custodian component.

17. The proximity tracking system of claim 13, wherein the custodian component includes a change proximity switch that enables manual selection of the predetermined distance.

18. The proximity tracking system of claim 13, wherein the custodian component includes an automatic reset switch that, upon manual actuation, cancels the generation of the proximity alert when the child component is moved beyond the predetermined distance and restores the proximity red alert generation function automatically as soon as the child component returns to a location within the predetermined distance.

19. The proximity tracking system of claim 13, wherein the custodian component includes a display screen that displays the predetermined distance on each tracking device interface.

20. The proximity tracking system of claim 13, wherein the custodian component includes an emergency switch is operative to cause each of the at least one child sensory alert generators to actuate without causing the custodian sensory alert sensors to actuate.
